(19) United States
(12) Patent Application Publication
(10) Pub. No.: US 2006/0168634 A1
(43) Pub. Date: Jul. 27, 2006

(54) Compressed video image transmission method and apparatus for allocating transmission capacity for reference images

(76) Inventors: Haruhiro Koto, Tokorozawa (JP); Yuichi Onami, Iruma (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/389,057

(22) Filed: Mar. 27, 2006

Related U.S. Application Data
(63) Continuation of application No. 10/253,639, filed on Sep. 25, 2002.

(30) Foreign Application Priority Data
Sep. 25, 2001 (JP) 2001-292666
Dec. 28, 2001 (JP) 2001-399493

(51) Int. Cl. H04N 7/173; H04N 11/04; H04N 11/02; H04N 7/12; H04B 1/66

(52) U.S. Cl. 725/105; 375/240.01

(57) ABSTRACT

A compressed image transmission system wherein desired one of a plurality of pieces of compressed video data transmitted onto a network from a plurality of transmission devices is selected at one of receiver terminals connected to the network and received to the receiver terminal. The transmission devices transmit reference images corresponding to the associated compressed video data to the network. Each of the receiver terminals displays the received reference image on a monitor, and an operator specifies the compressed video data to be received on the basis of the display state of the reference image.

### REFERENCE IMAGES

The present application is a continuation of application Ser. No. 10/253,639, filed Sep. 25, 2002, the contents of which are incorporated rein by reference.

### BACKGROUND OF THE INVENTION

The present invention relates to a compressed video transmission apparatus and method and more particularly, to a video image transmission technique including a plurality of motion picture compression apparatuses and a plurality of motion picture display apparatuses which are mutually connected in a network.

In recent years, an image processing technique, in particular, a technique for image and voice information is remarkably developed. This has resulted in that, even when a transmission line has a small capacity, it is possible for the line to transmit high quality motion picture or voice. For example, in the case where it is desired to monitor the condition of a subject at a remote location via a network, even when a transmission line has a small data transmission capacity, a combination with a motion picture data compression apparatus enables transmission of a high quality of motion picture.

Further, use of such an image compression technique has enabled transmission of a plurality of pieces of motion picture data through a transmission line having such a data transmission capacity that could transmit only a single piece of motion picture when used in the prior art.

For example, when a plurality of motion picture data compression devices are connected to a network to compress motion pictures picked up by cameras and transmit the processed picture via the network, this system can be used for an application such as remote monitoring. A plural pieces of motion picture compressed data obtained by compressing video images from cameras (“video image from camera” is hereinafter referred to as camera video) and transmitted to the network are expanded by a motion picture data expansion device in a receiver terminal connected to the same network to be displayed on a monitor screen.

FIG. 2 shows one of possible examples of arrangement of a compressed video transmission apparatus having such a plurality of motion picture data compression devices and a receiver terminal as mentioned above connected to a network. This arrangement was devised by the inventors of this application.

In a sender side, a plurality of combinations each having a camera for outputting video data and an encoder for compressing the video data are connected to the network. In this example, combinations having three cameras 1-1, 1-9 and 2-3 are connected to a network 1-25.

The network 1-25 may be network lines which can multiplex a plurality of pieces of data.

A video signal 1-2 output from the camera 1-1 is compressed by an encoder 2-1. Compressed data 1-4 issued from the encoder 2-1 is output to the network 1-25.

Similarly, a video signal 1-10 issued from the camera 1-9 is compressed by an encoder 2-2 and output to the network 1-25 as compressed data 1-12. A video signal 2-4 issued from the camera 2-3 is compressed by an encoder 2-5 and output to the network 1-25 as compressed data 2-6. Explanation has been made above as to the structure of the compressed data sender side.

In a receiver side, on the other hand, a plurality of combinations each having a decoder for expanding compressed data and a monitor are connected to the network. In this example, one combination of a decoder 1-27 and a monitor 1-31 is illustrated as connected to the network.

The decoder 1-27 receives any of three pieces of compressed data transmitted to the network 1-25 as compressed data 1-26 to expand the received data. And the expanded image data is output to the monitor 1-31 as a video signal 1-28.

An operator console 1-32 is provided for the purpose of changing over the camera videos from one video image to another while viewing the camera video being displayed on the monitor 1-31. In the illustrated example, three cameras are connected on the sender side but the operator can select one of the video images from these cameras to display the selected video image on the monitor 1-31. When the operator selects one of the cameras using the operator console 1-32, the console issues a camera selection signal 1-33 to a compressed data selector 1-34. The compressed data selector 1-34 judges one of the video data pieces of the cameras selected by the operator console 1-32 on the basis of the contents of the camera selection signal 1-33, and outputs to the decoder 1-27 a compressed data selection signal 1-35 to select one of the compressed data pieces corresponding to the camera in question.

Explanation will next be made as to the operation of the compressed video transmission apparatus having the plurality of motion picture data compression devices and the plurality of receiver terminals connected to the network in FIG. 2.

The video signal 1-2 issued from the camera 1-1 is compressed by the encoder 2-1.

In the above video image compressing operation, the video signal is subjected to digital processing to remove redundant information in the video image therefrom, thus reducing the size of the data. For this reason, when the operator views the video image after compression, he will little feel the deterioration of the video image quality. As the information is cut off for the purpose of further decreasing the data size, the operator can observe a visible video deterioration. However, since consideration is paid to human's eye characteristics for such deterioration, the deterioration is not to such an extent that the operator cannot identify what is the displayed video image, though he can sense somewhat deterioration that a fine part in the image is represented as blurred or unclear.

The video signal 1-2 having a reduced data size after compressed by the encoder 2-1 is output to the network 1-25 as the compressed data 1-4.

Similarly, the video signal 1-10 output from the camera 1-9 is compressed by the encoder 2-2 and output therefrom as the compressed data 1-12, while the video signal 2-4 output from the camera 2-3 is compressed by the encoder 2-5 and output as the compressed data 2-6.

As a result, three pieces of motion picture compressed data of the compressed data 1-4, 1-12 and 2-6 are input to the network 1-25.

Since the network 1-25 has a finite data transmission capacity, the three compressed data must be controlled so that a total amount of the tree compressed data will not exceed the transmission capacity.

To this end, in the video image compressing operation, the three encoders connected to the network are designed so that a total compressed data of the video signals compressed by the encoders will not exceed the network transmission capacity. A simplest way of realizing it is, when the tree encoders are connected to the network 1-25 as in this example, to design so that the amount of compressed data of each of the three encoders can be limited to a level that corresponds to one of equal three divisions of the network transmission capacity. Since the transmission capacity of the network is already determined, the limitation of the transmission capacity of the compressed output data of each encoder can also be found from the number of encoders connected to the network 1-25. When the network transmission capacity is equally divided by the number of cameras, each capacity division corresponds to a maximum transmission capacity allocated to each compressed data.

In order to perform such camera video compression as not to deteriorate the video quality, it is desirable to make large the size of the compressed data as much as possible. To this end, the video compression is carried out so that a total size of the compressed data corresponds to the maximum transmission capacity. The operation of the sender side has been explained above.

In the receiver side, the decoder 1-27 receives and expands any of the compressed data 1-4, 1-12 and 2-6 transmitted from the network 1-25. Which one of these compressed data is to be selected is determined in accordance with the compressed data selection signal 1-35.

The decoder 1-27 performs expanding operation to return the received compressed data to the original video signal. The video signal 1-28 expanded by the decoder 1-27 is sent to the monitor 1-31 to be displayed thereon as the camera video.

The operator console 1-32 is provided close to the monitor 1-31 to allow selection of one of video images taken by a plurality of cameras. For example, the operator allocates numbers to these cameras so as not to overlap and can select one of the camera videos by pushing a button corresponding to the number to be selected. Alternatively, a lever or button provided on the operator console 1-32 may be operated to switchingly change the camera videos sequentially. Further, when the operator console 1-32 comprises a touch panel, the panel can be built in the monitor 1-31 so that the panel can play a role of the console 1-32 by the operator who touches the display screen of the monitor 1-31 by operator's finger or with a pencil. The monitor 1-31 can also used commonly as the monitor of a computer, so that, when the camera video is overlapped with the computer screen, the computer can be used also as the operator console 1-32.

Information on the camera video selected by the operator console 1-32 is output to the compressed data selector 1-34 as the camera selection signal 1-33. For example, assuming that the video of the camera 1-1 is selected by the operator console 1-32, then the camera selection signal 1-33 indicative of the camera 1-1 is output to the compressed data selector 1-34.

The compressed data selector 1-34 selects the compressed data to be expanded on the basis of the information about the received camera selection signal 1-33. In the illustrated example, the compressed data corresponding to the camera 1-1 is the compressed data 1-4, the compressed data corresponding to the camera 1-9 is the compressed data 1-12, and the compressed data corresponding to the camera 2-3 is the compressed data 2-6.

Through the aforementioned operation, the operator can select the compressed data corresponding to one of the plurality of cameras with use of the operator console 1-32 to display the selected camera video on the monitor 1-31.

Next, with the aforementioned arrangement, an exemplary example of the display screen of the monitor 1-31 is shown in FIG. 3 and explanation will be made as to how to select one of the camera videos.

In this example, the monitor 1-31 is the display screen of the computer and the selected camera video is displayed on a part of the computer display screen as overlapped therewith. In this case, the operator console 1-32 is an input device to the computer, which is, for example, a keyboard or mouse connected to the computer.

FIG. 3 shows an example of a display image 3-6 displayed on the monitor 1-31, on which a camera video 3-1, a selection button 3-2 of the camera 1-1, a selection button 3-3 of the camera 1-9, a selection button 3-4 of the camera 2-3, and an instructing pointer 3-5 are shown.

The camera video 3-1 is a video image obtained by compressing the camera video in the sender side, transmitting it to the network 1-25 and expanding it by the decoder 1-27 in the receiver side. In this example, since there are three cameras in the sender side, any of three sorts of camera videos is displayed.

The selection button 3-2 is used to select the camera 1-1. Similarly, the selection button 3-3 is used to select the camera 1-9 and the selection button 3-4 is to select the camera 2-3. In this selection method, the operator can select one of the cameras by moving the instructing pointer 3-5 (which can be freely moved on the display screen) onto the selection button with use of the operator console 1-32 and further by issuing a command for determination of the camera selection from the operator console 1-32. When a mouse is connected to the operator console 1-32 for example, the operator can determine the camera selection by moving the instructing pointer 3-5 on the display screen, stopping the pointer on the desired selection button, and pushing the mouse button.

Through such operations as mentioned above, the operator can select one of the three cameras connected to the sender side and display it on the monitor 1-31 as the camera video 3-1.

Though explanation has been made in connection with the case where the input device connected to the operator console 1-32 is the mouse, the mouse may be replaced by a keyboard so that the operator can select any of the three camera videos by pushing a desired key on the keyboard.

In addition, the display positions and sizes of the camera video 3-1, selection button 3-2, selection button 3-3, selection button 3-4 and instructing pointer 3-5 on the monitor display image 3-6 are not required to be the same as the illustrated positions and sizes and may be modified as necessary.

By the aforementioned camera selection method, the plurality of camera videos connected to the network can be switched, but the monitor display image 3-6 can display only one camera video. Thus, when a plurality of cameras are connected to the network, the operator can know which camera currently takes what sort of video image only after actually changing the camera switchingly with use of the operator console 1-32.

In the case where three cameras are connected to the network, if it is desired to display the camera videos of the three cameras on the display image 3-6 of the monitor 1-31 at the same time, then the transmission capacity of the network 1-25 is required to be the same as the amount of data received by the decoder in the receiver side. For this reason, such motion picture data cannot be transmitted through a transmission line having a small data transmission capacity. Further it is actually difficult from the viewpoint of a processing speed that the decoder 1-27 process the plurality of pieces of compressed data requiring the network to have such a large data transmission capacity.

When a plurality of pieces of camera videos are compressed in the sender side and transmitted to the network, all the compressed data cannot be processed due to the limitation of the transmission capacity of the receiver side. Thus only after switchingly changing the camera video with use of the operator console, the operator can confirm the contents of the received camera video.

### SUMMARY OF THE INVENTION

It is an object of the present invention to remove such problems, that is, to solve the problem that, when a plurality of camera videos are compressed in a sender side and transmitted to a network, all the compressed data cannot be processed due to limitation of the transmission capacity of a receiver side, and only after switchingly changing the camera video with use of an operator console, an operator can confirm the contents of the received camera video.

Further, in actual applications, there sometimes occurs such a case there five or more cameras are required to be connected to a transmission line having a maximum capacity as large as, e.g., the video images of, e.g., four cameras can be transmitted at the same time.

Another object of the present invention is to provide a compressed video transmission apparatus which, even in such a case as mentioned above, can switchingly change a camera video while judging in a receiver side which camera video can be transmitted.

In accordance with an aspect of the present invention, there is provided an apparatus for transmitting compressed video image via a network, which comprises a plurality of video transmission devices each having an image pickup device and connected to transmit compressed data of a video captured by the image pickup device and a reference image of the video image to the network, part of a transmission capacity of the network is allocated for transmission of the reference image; and at least one video receiver device connected to the network and including a monitor for displaying the respective reference images received via the network and an operating device for allowing an operator to select desired one of the reference images, the monitor displaying the respective reference images and the video image corresponding to the selected reference image.

In an embodiment, in order to generate the reference image from the video, each of the video transmission device includes an encoder for generating highly compressed data having a compression rate higher than the compressed data of the video image and having a data size smaller than the video image from the video.

In an embodiment having N video transmission devices and having a network with a transmission capacity Q, Q/(N+1) is allocated to each of the video transmission devices and a total of transmission capacity of Q/(N+1) is allocated to transmission of the reference images.

In accordance with another aspect of the present invention, there is provided a compressed video image transmission apparatus for transmitting a compressed video image via a network, which comprises a plurality of video image transmission devices connected to the network each for generating compressed video image data; and at least one video receiver device connected to the network and including at least one monitor, each of the plurality of video transmission devices including a reference image generator for generating a reference image corresponding to the compressed video data generated by each video transmission device and transmitting the compressed data to the network, the video receiver device including a transmission state monitor for monitoring a transmission state of the compressed video image data corresponding to the reference image generated by the each video transmission device and displaying the state on the monitor in association with the reference image, and an operating device for allowing an operator to instruct desired one or ones of the compressed video data to be received on the basis of the displayed transmission state.

In an embodiment, the transmission state of the compressed video image data includes a state wherein the compressed data of interest is present on the network and if selected, the compressed data can be displayed on the monitor as video image data; a state wherein the compressed data of interest is not present on the network, the network does not have any available, unused or unoccupied transmission capacity, and even if selected, the compressed data cannot be transmitted; and a state wherein the compressed data of interest is not present on the network but the network has an available, unused transmission capacity so that, if selected, the compressed data can be transmitted.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a configuration of a compressed video image transmission apparatus with reference display screens in accordance with an embodiment of the present invention;

FIG. 2 is a block diagram showing an exemplary configuration of a compressed video transmission apparatus which was examined in the course of making the present invention;

FIG. 3 is a schematic diagram showing an example of a display screen of a monitor in the apparatus of FIG. 2;

FIG. 4 is a schematic diagram showing an example of a display screen of a monitor with reference screens in the embodiment of FIG. 1;

FIG. 5 is a diagram showing how to divide the transmission capacity of a network in the apparatus of FIG. 2;

FIG. 6 is a diagram showing how to divide the transmission capacity of a network with reference screens in the present invention;

FIG. 7 is a diagram showing how to divide the transmission capacity of the network when connected with six cameras;

FIG. 8 is a block diagram showing an overall configuration of a compressed video transmission apparatus in accordance with another embodiment of the present invention;

FIG. 9 is a schematic diagram of a display screen of a monitor in the present invention;

FIGS. 10A to 10D are diagrams showing reference images and the states of compressed data in the present invention respectively;

FIG. 11 is a flowchart showing the operation of a transmission information detector; and

FIG. 12 is a flowchart showing the operation of a compressed data selector.

### DESCRIPTION OF THE EMBODIMENTS

Embodiments of the present invention will be explained with reference to the accompanying drawings, wherein substantially the same members are denoted by the same reference numerals.

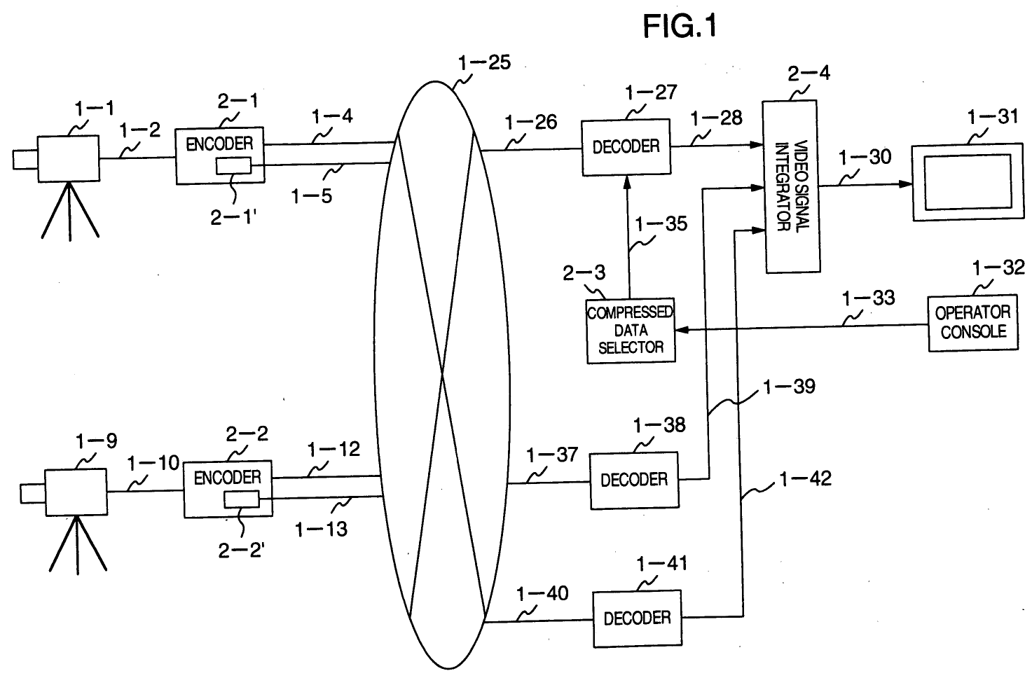

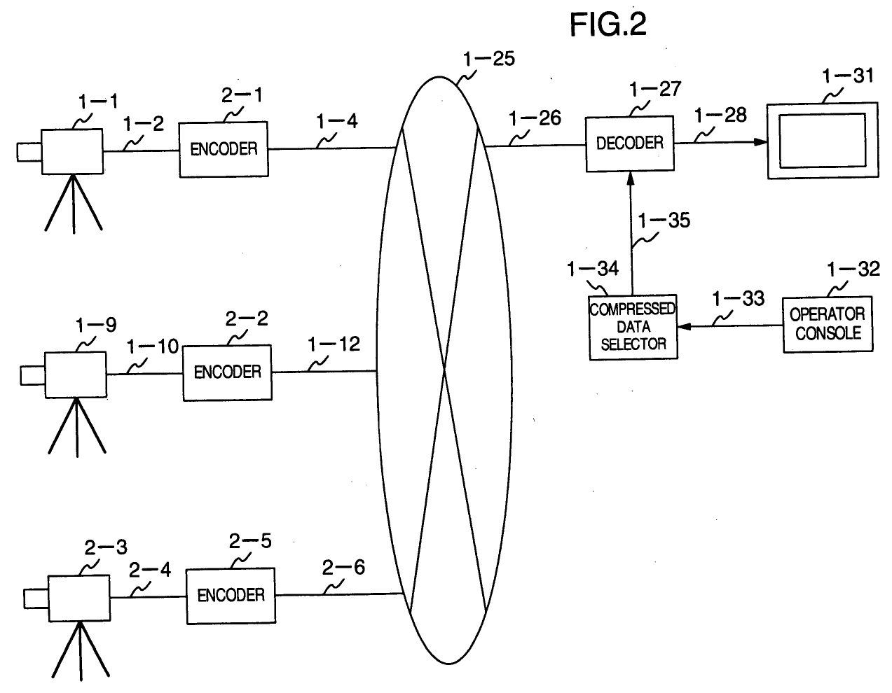

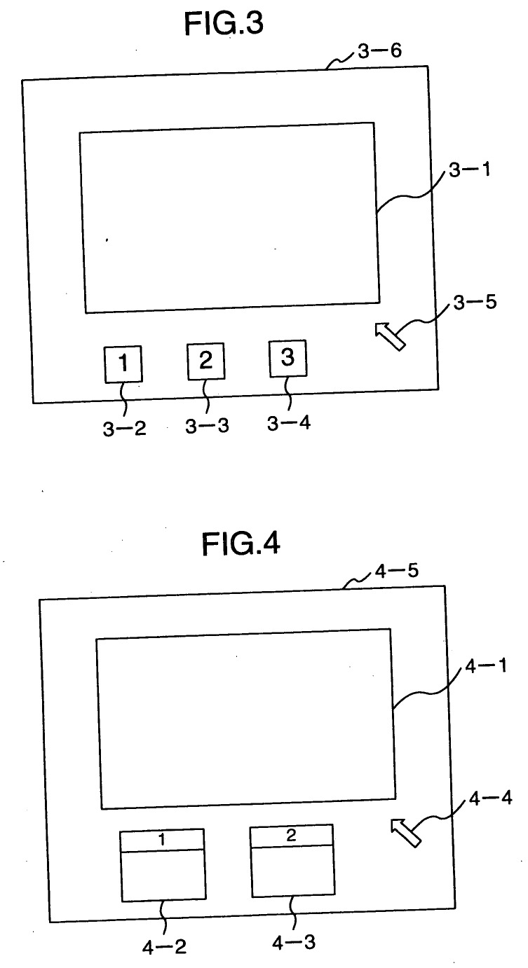

FIG. 1 shows a configuration of a compressed video transmission apparatus in accordance with an embodiment of the present invention wherein a plurality of motion picture data compression devices and a receiver terminal are connected to a network.

In a sender side, a plurality of combinations each including a video data output apparatus such as a camera and an image pickup device for outputting video data (explanation will be made taking, as an example, a camera hereinafter) and an encoder for compressing the video data are connected to a network. In the illustrated example, two cameras 1-1 and 1-9 are provided and two combinations thereof are connected to a network 1-25.

A video signal 1-2 output from the camera 1-1 is compressed by an encoder 2-1. The encoder 2-1 may employ an arbitrary image compression system. For example, MPEG-1/2/4, JPEG or another system may be used. Compressed data 1-4 output from the encoder 2-1 is output to the network 1-25.

Further, the encoder 2-1 also compresses the video signal 1-2 with a high compression rate, and outputs the compressed data as reference screen data 1-5. As the video compression system having the high compression rate, any system may be employed in addition to the aforementioned MPEG-1/2/4 and JPEG. The compression rate of any of these compression systems can be modified. Thus the compression system for generating the compressed image data may be the same as the compression system for generating the reference image data. Alternatively, the compressed image data may be based on MPEG-2 which generates high definition image data, while the reference image may be based on MPEG-4 that provides low bit rate compression as its specialty, as a system combination. The encoder 2-1 may be designed to include another encoder 2-1′ for generating the reference image. Here, the reference screen data 1-5 is featured by having a high compression rate. For this reason, the video signal 1-2 is first converted to image data having a size smaller than the image size of the video signal, and then compressed. Alternatively, a frame rate is made smaller than that of the video signal 1-2 and then the reference image data is compressed to thereby realize a higher compression rate. Furthermore, the reference image is not required to have a quality corresponding to a high definition image like the compressed data 1-4, but may be allowed to be a deteriorated image. The image deteriorated to some extent enables a higher image compression.

Similarly, a video signal 1-10 output from the camera 1-9 is compressed by an encoder 2-2 and output to the network 1-25 as compressed data 1-12. Further, the video signal 1-10 is compressed with a high compression rate and output to the network 1-25 as reference screen data 1-13. To this end, another encoder 2-2′ may be included in the encoder 2-2. The structure of the sender side has been explained above.

In a receiver side, on the other hand, a plurality of combinations each including a decoder for expanding the compressed data transmitted from the network and a monitor are connected to the network 1-25. In the illustrated example, a combination including a decoder 1-27 and a monitor 1-31 is connected to the network.

The decoder 1-27 receives any one of the two pieces of compressed data 1-4 and 1-12 as compressed data 1-26 and expands it. The expanded image data is output to a video signal integrator (synthesizer or combiner) 2-4 as a video signal 1-28.

A decoder 1-38 receives reference screen data 1-5 from the network 1-25 as reference screen data 1-37, expands it, and then outputs the expanded data to the video signal integrator 2-4 as reference video image 1-39.

A decoder 1-41 receives the reference screen data 1-13 from the network 1-25, expands it, and then outputs the expanded data to the video signal integrator 2-4 as reference video image 1-42.

The video signal integrator 24 combines the video signal 1-28 and reference video images 1-39 and 1-42 into a composite signal, and outputs the composite signal to the monitor 1-31 as a composite video signal 1-30 as video data corresponding to one display screen.

An operator console 1-32 is provided to transmit to the sender side an instruction signal to select one of the cameras while viewing the video image on the monitor 1-31. The structure of the operator console 1-32 is similar to that of a conventional console. When the operator selected one camera with use of the operator console 1-32, information relating the selection is output to the compressed data selector 2-3 as camera selection signal 1-33.

The compressed data selector 2-3 judges the video image data of the camera selected by the operator console 1-32 on the basis of the contents of the camera selection signal 1-33. And the compressed data selector 2-3 outputs to the decoder 1-27 the compressed data selection signal 1-35 to select the compressed data corresponding to the selected camera video. The decoder 1-27, on the basis of the information of the compressed data selection signal 1-35 received from the compressed data selector 2-3, selects the compressed data to be expanded.

Explanation will next be made as to the operation of the compressed video transmission apparatus based on the invention of FIG. 1 wherein the plurality of motion picture data compression devices and the receiver terminal are connected to the network.

The video signal 1-2 issued from the camera 1-1 is compressed by the encoder 2-1 and output to the network 1-25 as the compressed data 1-4. At the same time, the encoder 2-1 or 2-1′ compresses the video signal 1-2 with a high compression rate and outputs the high-compressed signal to the network 1-25 as the reference screen data 1-5. Though the compressed data 1-4 and the reference screen data 1-5 have been generated from the same original video, the sizes of their compressed data are largely different from each other, that is, a ratio of the reference screen data 1-5 to the compressed data 1-4 is from 1/10 to 1/100.

Similarly, video data 1-10 issued from the camera 1-9 is compressed by the encoders 2-2 and 2-2′ and is output as the compressed data 1-12 and reference screen data 1-13.

As a result, four motion picture compressed data of the compressed data 1-4 and 1-12 and of the reference screen data 1-5 and 1-13 are input to the network 1-25. As in the prior art, the network 1-25 has a definite transmission capacity and a total amount of the four compressed data is required to be controlled so that the total amount does not exceed the network transmission capacity.

In this case, for example, the size of each of the compressed data 1-4 and 1-12 is limited to a value corresponding to one of equal 3 divisions of the transmission capacity of the network 1-25 of the prior art. The compressed data 14 and 1-12 occupy 1/3 of the transmission capacity, respectively, and the remaining transmission capacity is used to transmit the reference screen data 1-5 and 1-13.

As mentioned above, when compared with the compressed data, the size of the reference screen data is as small as 1/10 or 1/100. Thus if a ratio of the reference screen data to the compressed data is 1/100 for example, then a combination of 100 of the reference screen data corresponds to the size of a single piece of the compressed data. This means that, when all the reference screen data are combined into a single piece of data, 100 of the reference screen data can be transmitted at the same time. How to divide the transmission capacity will be detailed later. The operation of the sender side has been explained above.

In the receiver side, in the decoder 1-27 connected to the network 1-25, the compressed data 1-4 or the compressed data 1-25 is taken into to expand the image data. Which one of the compressed data 1-4 and the compressed data 1-12 is to be taken into the network 1-25 is determined by the compressed data selection signal 1-35. The decoder 1-27 expands the compressed data 1-4 or 1-12 to the original video signal.

The video signal 1-28 of the compressed data expanded by the decoder 1-27 is output to the video signal integrator 2-4.

The decoder 1-38 receives the reference screen data 1-5 as the reference screen data 1-37 via the network 1-25, expands the data, and then outputs the expanded data to the video signal integrator 2-4 as the reference video signal 1-39.

Similarly, the decoder 1-41 receives the reference screen data 1-13 as reference screen data 1-40 via the network 1-25, expands the data, and then outputs the expanded data to the video signal integrator 2-4 as the reference video signal 1-42.

The video signal integrator 2-4 inputs three video signals of the video signal 1-28 and reference video signals 1-39 and 1-42. These video signals are subjected by the video signal integrator 2-4 to overlapping operation so that these signals can be displayed at positions corresponding to the layout of the display screen of the monitor 1-31, and then output therefrom to the monitor 1-31 as the composite video signal 1-30 corresponding to a single screen of image. The screen layout will be explained later.

The monitor 1-31 displays the composite video signal 1-30 as the camera video. All the reference video images are displayed on the display screen of the monitor 1-31, and the operator can grasp each and every camera picking up what scene.

The operator console 1-32 is provided in the vicinity of the monitor 1-31 so that the operator can select one of the camera videos with use of the operator console 1-32 on the basis of a plurality of the reference video images displayed on the display screen. Information on the camera video selected by the operator console 1-32 is output to the compressed data selector 2-3 as the camera selection signal 1-33.

The compressed data selector 2-3 judges the camera video selected by the operator console 1-32 from the contents of the received camera selection signal 1-33. And the compressed data selector 2-3 outputs the compressed data selection signal 1-35 to the decoder 1-27 to select the compressed data corresponding to the selected camera video. The decoder 1-27, on the basis of the information of the compressed data selection signal 1-35 received from the compressed data selector 2-3, selects the compressed data to be expanded. In the illustrated example, the compressed data corresponding to the camera 1-1 is the compressed data 14 and the camera 1-9 is associated with the compressed data 1-12.

Through the aforementioned operations, the operator selects one of the compressed data corresponding to one of the plurality of cameras while viewing the reference video images with the use of the operator console 1-32 to thereby display the desired camera video on the monitor 1-31.

With the aforementioned arrangement, FIG. 4 shows an example of display on the display screen of the monitor 1-31 in the present invention. Explanation will next be made as to how to select the camera videos.

In this example, the monitor 1-31 comprises a computer display screen, on which a camera video is displayed as overlapped partly with the computer display screen. In this case, the operator console 1-32 is an input device to the computer, which is, e.g., a keyboard or mouse connected to the computer.

FIG. 4 shows an example of a monitor display image 4-5 displayed on the monitor 1-31, on which a camera video 4-1, reference screens 4-2 and 4-3, and an instructing pointer 4-4 are displayed.

The camera video 4-1, which was obtained by compressing a camera video in the sender side, transmitting it to the network 1-25 and then expanding it in the decoder 1-27 of the receiver side, is displayed. In this example, since there are provided two cameras in the receiver side, any of two sorts of camera videos is displayed.

The reference video image after being picked up by the camera 1-1 and reduced in size is displayed on the reference screen 4-2; and the reference video image after being picked up by the camera 1-9 and reduced in size is displayed on the reference screen 4-3.

The reference screen 4-2 is used to display and select the video taken by the camera 1-1. Similarly, the reference screen 4-3 is used to display and select the video taken by the camera 1-9. One of the camera videos is selected by the operator who moves the instructing pointer 4-4 (which can be freely moved on the display screen) onto the reference display screen and issues an instruction command to determine it with use of the operator console 1-32. For example, when a mouse is connected to the operator console 1-32, one of the camera video is determined by the operator who moves the mouse to move the instructing pointer 4-4 onto the monitor display image 4-5, stops the pointer on the desired selected reference display screen and then pushes a mouse button.

Through such operations as mentioned above, the operator can select one of the two connected cameras while viewing the video images currently being taken by the cameras on the basis of the reference display screens and can display the selected video image on the monitor 1-31 as the camera video 4-1.

In this connection, the display positions and sizes of the camera video 4-1, reference screens 4-2 and 4-3 and instructing pointer 4-4 in the monitor display image 4-5 are not required to be the same as those of this drawing, and various layouts are considered.

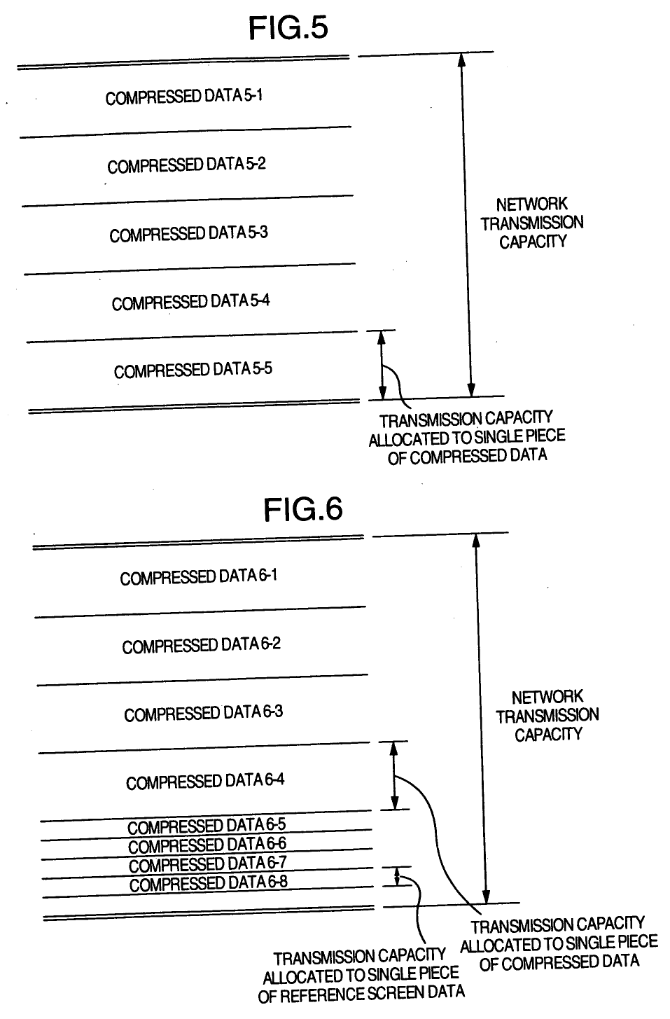

Explanation will then be made as to how to divide the transmission capacity of the network with use of examples of FIGS. 5 and 6.

In a prior art compressed video transmission apparatus wherein a plurality of motion picture data compression devices and a receiver terminal are connected to a network, it is assumed that five cameras are provided in a sender side.

In order to transmit video images of the five cameras so as not to exceed the transmission capacity of the network, for example, it is only required to equally divide the network transmission capacity into five amounts and to allocate these five divisions to the respective encoders connected to the cameras. When the numbers 5-1 to 5-5 of five compressed data output from the encoders are given to the five compressed data sequentially, the transmission capacity of the network is equally divided into five amounts as shown in FIG. 5.

Meanwhile, how to divide the network transmission capacity based on the present invention is shown in FIG. 6. First, the number of cameras provided in the sender side is reduced by 1, that is, is set at four. The transmission capacity of the network is equally divided into five amounts as in the prior art of FIG. 5. Since the number of the cameras is four, one of the equal divisions of the transmission capacity corresponding to one piece of compressed data is left unused. The left, unused transmission capacity amount is allocated to all the reference screen data issued from the sender side.

Since one piece of compressed data and one piece of reference screen data are issued from a single encoder, provision of the four cameras means presence of four pieces of reference screen data.

Further, as mentioned above, the ratio of the reference screen data to the compressed data is as small as 1/10 to 1/100. Thus if the ratio is 1/10 for example, then even a combination of all the four pieces of reference screen data is smaller than the size of the single piece of compressed data. Therefore, even when all the reference screen data are combined and allocated to the unused transmission capacity amount, the sum of all the transmission data capacities will not exceed the network transmission capacity.

The same holds true even when the number of cameras provided in the sender side is increased. That is, in the case where 99 cameras are connected in the sender side and the ratio of the reference screen data to the compressed data is set at 1/100, even a combination of all the reference screen data will not exceed the transmission capacity of the network.

This relationship is generally expressed as follow. That is, assuming that N cameras are provided in a sender side, then the transmission capacity of compressed data allocated to one encoder corresponds to one of equal (N+1) divisions of the transmission capacity of the network, and the ratio of the reference screen data to the compressed data is 1/(N+1). When the above limitation conditions of the transmission capacity are satisfied, the transmission capacity of the network can be fully used. In practice, there is sometimes a case where the limitation conditions is modified so that a part of the transmission capacity of the network may be left unused so as to avoid critical setting.

As mentioned above, when the compressed data of the encoders and the reference screen data in the sender side are output at the same time and part of the transmission capacity of the network is allocated to the transmission of the reference screen data, the operator can select one of the cameras while viewing the reference display screens in the receiver side.

In accordance with the embodiment mentioned above, there can be realized a compressed video transmission apparatus wherein the operator can switchingly change the camera videos while viewing the reference display screens in the receiver side.

Explanation will next be made as to another embodiment of the present invention.

In the aforementioned embodiment, the encoders simultaneously output the compressed data and the associated reference image data and part of the transmission capacity of the network is allocated to the transmission of the reference image data, whereby the operator can select one of the cameras while viewing the reference images in the receiver side.

In some practical cases, however, five or more cameras or monitors are required to be connected to a transmission line having such a transmission capacity that can transmit, e.g., video images of four cameras at the same time.

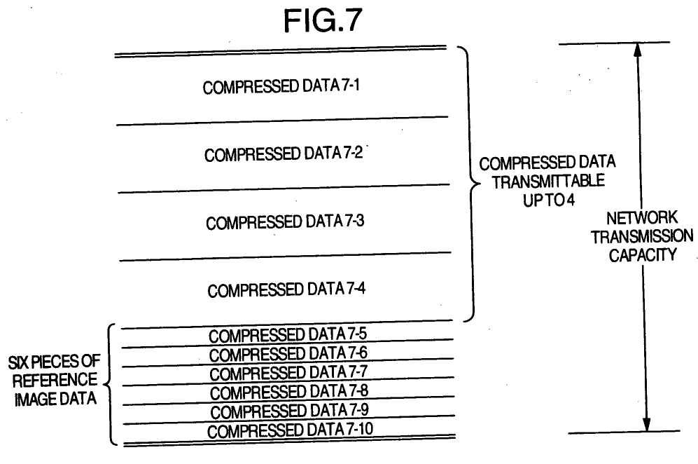

A division of the transmission capacity in such a case will be explained in connection with an example of FIG. 7. In this example, six cameras are assumed to be connected to a network. It is also assumed that four pieces of data, that is, compressed data 7-1 of a first camera, compressed data 7-2 of a second camera, compressed data 7-3 of a third camera, and compressed data 7-4 of a fourth camera are transmitted to a network having such a transmission capacity that can transmit the video images of the four cameras at the same time. Since the number of cameras is six, six pieces of data of reference image data 7-5, 7-6, 7-7, 7-8, 7-9 and 7-10 are transmitted.

Under such transmission conditions, it is assumed that a new receiver terminal issued a request to receive data obtained by compressing the video of the third camera. Then since the compressed data 7-3 corresponds to the video image of the third camera, the receiver terminal is only required to receive the compressed data 7-3. If the new receiver terminal issued a request to receive data obtained by compressing the video of the fifth camera, there is no unused part in the transmission capacity, it is impossible to transmit the compressed data of the new fifth camera. In addition, since the user of the receiver terminal side selects one of the camera videos by just viewing the reference images displayed on the monitor, he cannot judge which camera vide can be transmitted. This is because the user does not know whether or not the transmission capacity of the network has a margin or a sufficient unused capacity for the transmission and, besides, the reference images are always transmitted regardless of the transmission capacity.

Eventually, when cameras larger in number than the allowable transmission capacity of the compressed data allocated to a single network are connected to the network, the user cannot judge whether or not the user can see the video of which camera only by viewing the reference images in the receiver terminal side.

The present embodiment is directed to a compressed video transmission apparatus in which, when switchingly changing the video of the camera while viewing the reference images in the receiver side, the user can do it after knowing which video can be transmitted.

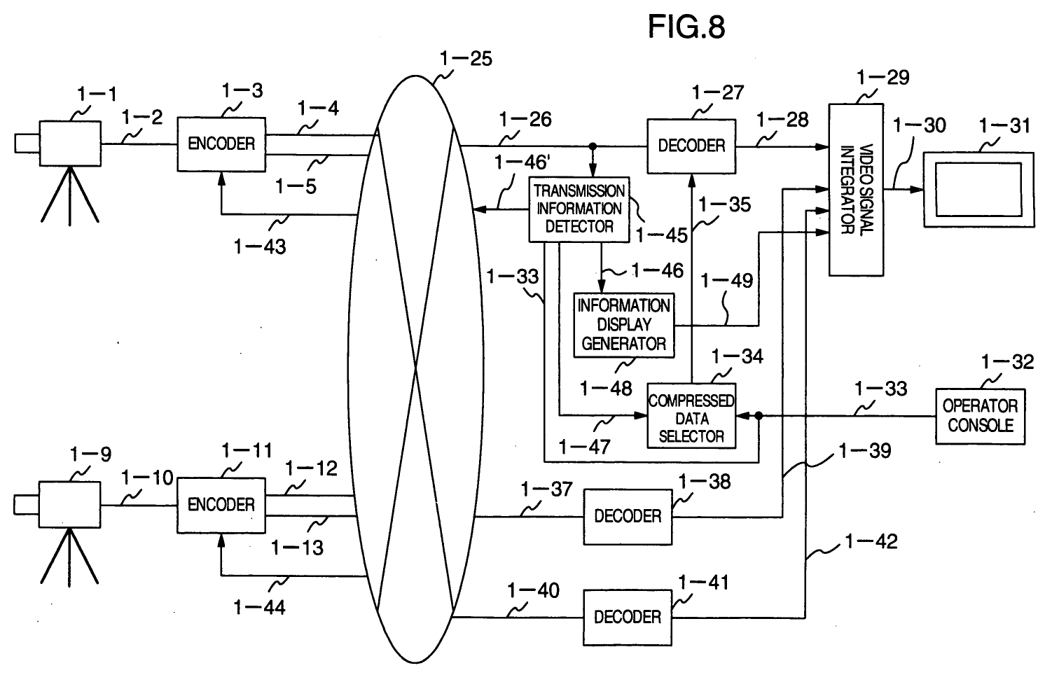

FIG. 8 shows a configuration of a compressed video image transmission apparatus in accordance with an embodiment of the present invention wherein a plurality of motion picture data compression devices and a receiver terminal are connected to a network. Explanation will be made in detail by referring to FIG. 8.

Provided in a sender side of the compressed video image transmission apparatus are a plurality of combinations which each includes a camera for outputting video data and an encoder for compressing the video data and which are connected to a network. In the illustrated example, two cameras 1-1 and 1-9 are provided and two combinations thereof are connected to a network 1-25.

A video signal 1-2 issued from the camera 1-1 is compressed by an encoder 1-3. Compressed data 1-4 issued from the encoder 1-3 is output to the network 1-25.

The encoder 1-3 also compresses the video signal 1-2 with a high compression rate and outputs it as reference screen data 1-5. The reference screen data 1-5 is featured by having the high compression rate.

Unlike the aforementioned embodiment, further, a transmission request data 1-43 is issued from the receiver terminal via the network 1-25 and input to the encoder 1-3.

Similarly, a video data 1-10 issued from a camera 1-9 is compressed by an encoder 1-11 and output to the network 1-25 as compressed data 1-12. The encoder 1-11 also compresses the video data 1-10 with a high compression rate and outputs it to the network 1-25 as reference screen data 1-13. Further, transmission request data 1-44 is output from the receiver terminal via the network 1-25 and transmitted to the encoder 1-11. The structure of the compressed data sender side has been explained above.

In the receiver side, next, a plurality of combinations each including a decoder for expanding the compressed data and a monitor are connected to the network. In this example, one set of the decoder 1-27 and monitor 1-31 is connected to the network. When two or more sets are provided, the sets are only required to be connected to the network.

In this example, the decoder 1-27 receives any one of the two compressed data 1-4 and 1-12 transmitted from the network 1-25 as compressed data 1-26 and expands the data. The expanded image data is output to a video signal integrator 1-29 as a video signal 1-28.

The decoder 1-38 receives the reference screen data 1-5 transmitted from the network 1-25 as the reference screen data 1-37, expands the received data, and then outputs the expanded data to the video signal integrator 1-29 as reference video signal 1-39.

The decoder 1-41 receives the reference screen data 1-13 transmitted from the network 1-25 as reference screen data 1-40, expands the received data, and then outputs the expanded data to the video signal integrator 1-29 as reference video signal 1-42.

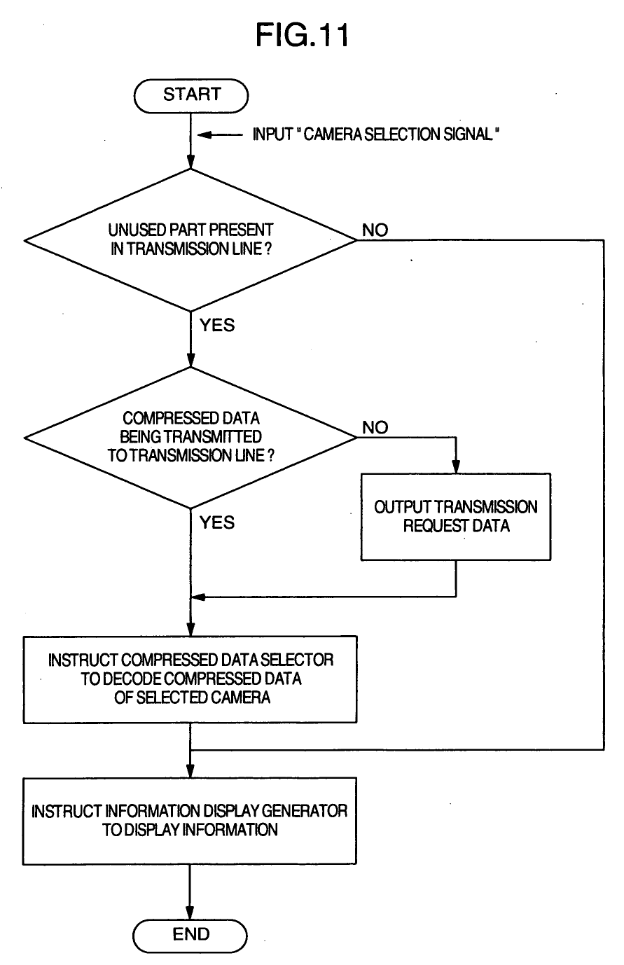

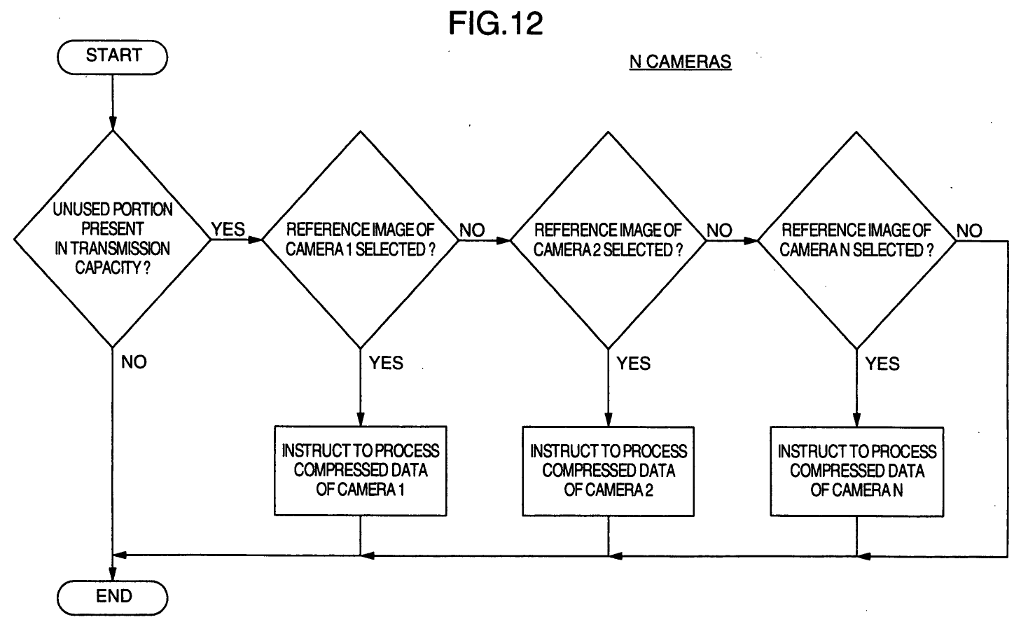

A transmission information detector 1-45 monitors compressed data on the network 1-25, detects that the compressed data was transmitted from which camera, or monitors the presence or absence of a unused part left in the network transmission capacity. The monitored result is output to the transmission information detector 145 as transmission information 1-46. On the basis of the detected result of the transmission data and the information of the camera selection signal 1-33, the transmission information detector 1-45 outputs a selector control signal 1-47 to the compressed data selector 1-34 to control the selector and outputs transmission request data 1-46′ (which will be explained later) to the network 1-25. The structures of the transmission information detector 1-45 and compressed data selector 1-34 are shown by flowcharts of FIGS. 11 and 12 respectively.

An information display generator 1-48, on the basis of the contents of the received transmission information 1-46, converts information about the presence or absence of a unused part in the network transmission capacity to image data (having an image and characters embedded therein), and outputs the image data to the video signal integrator 1-29 as information display video 1-49.

The video signal integrator 1-29 combines the received video signal 1-28, reference video signal 1-39 and 1-42 and information display video 1-49 into a composite video signal 1-30 corresponding to a single screen of image data, and outputs the composite signal to the monitor 1-31.

The operator console 1-32 is provided for the purpose of the user who sends an instruction signal to the sender side to select the desired camera video while viewing the video images of the monitor 1-31. The structure of the operator console 1-32 is similar to that in the prior art. The camera selection signal 1-33 issued from the operator console 1-32 is output to the compressed data selector 1-34 and the transmission information detector 1-45.

The compressed data selector 1-34 judges the video image of which camera is selected by the operator console 1-32 from the contents of the camera selection signal 1-33. Further, when it is found from the contents of the selector control signal 1-47 that the compressed data from the selected camera is not present on the network because of shortage of the network transmission capacity, a camera selection request from the operator console 1-32 is discarded. As a result, the compressed data selector 1-34 selects the compressed data corresponding to the selected camera and outputs it to the decoder 1-27 as the compressed data selection signal 1-35.

Next, explanation will be made as to the operation of the compressed video transmission apparatus of the present invention when the plurality of motion picture data compression devices and the receiver terminal with the reference images are connected to the network as shown in FIG. 8.

With regard to the video signal 1-2 issued from the camera 1-1, when the encoder 1-3 judges from the contents of the received transmission request data 1-43 that its compressed data be output, the encoder compresses the video signal 1-2 and outputs the compressed data to the network 1-25 as the compressed data 1-4. At the same time, the encoder 1-3 also compresses the video signal 1-2 with a higher compression rate independently of the contents of the transmission request data 1-43 and outputs the reference screen data 1-5 to the network 1-25. The compressed data 1-4 and the reference screen data 1-5 are both based on the same video image, but their compressed data sizes are largely different from each other. For example, the ratio of the reference screen data 1-5 to the compressed data 1-4 is 1/10 to 1/100.

Similarly, the video data 1-10 issued from the camera 1-9 is compressed by the encoder 1-11 and output as the compressed data 1-12 and reference screen data 1-13. In this connection, when the encoder 1-11 judges from the contents of the received transmission request data 1-44 that output of its compressed data is not required, the encoder outputs the reference screen data 1-13 alone. Thereby the network transmission capacity can be effectively used.

As a result, four video compressed data of the compressed data 1-4 and 1-12 and reference screen data 1-5 and 1-13 are input to the network 1-25. Since the compressed data selection signal 1-25 has a finite transmission capacity, it is required to control the four compressed data so that a total of the four data will not exceed the network transmission capacity as in the first-mentioned embodiment.

However, when the contents of the transmission request data 1-43 and 1-44 do not indicate to output their compressed data, the compressed data 1-4 and 1-12 will not be output and a unused or idle part is generated in the transmission capacity of the network 1-25. The operation of the sender side has been explained above.

In the receiver side, on the other hand, the decoder 1-27 connected to the network 1-25 receives any of the compressed data 1-4 and 1-12 transmitted onto the network 1-25 and expands the received data. In this case, which one of the compressed data is to be received is determined by the compressed data selection signal 1-35.

The decoder 1-27 expands any of the compressed data 1-4 and 1-12 to the original video signal. The video signal 1-28 expanded by the decoder 1-27 is output to the video signal integrator 1-29.

The decoder 1-38 receives the reference screen data 1-5 via the network 1-25 as the reference screen data 1-37. And the decoder expands the received data to a signal and outputs the signal to the video signal integrator 1-29 as the reference video signal 1-39.

Similarly, the decoder 1-41 receives the reference screen data 1-13 via the network 1-25 as the reference screen data 1-40. And the decoder 1-41 expands the received reference data to a signal and outputs the expanded signal to the video signal integrator 1-29 as the reference video signal 1-42.

The transmission information detector 1-45 monitors the compressed data on the network 1-25, and outputs information about whether or not the compressed data from which camera is transmitted or about the presence or absence of a unused or idle part in the network transmission capacity to the information display generator 1-48 as the transmission information 1-46. If there is no idle or unused part in the network transmission capacity and the contents of the camera selection signal 1-33 received from the operator console 1-32 indicates selection of the camera corresponding to the compressed data not present on the network 1-25, then the transmission information detector 1-45 outputs the selector control signal 1-47 to the compressed data selector 1-34 so as not to select the compressed data in question. The transmission information detector 1-45 also specifies the corresponding camera from the information indicative of the selected compressed data and outputs the transmission request data 1-46′. The transmission request data 1-46′ is input via the network 1-25 to the encoder 1-3 or encoder 1-11 in the sender side. In this connection, the transmission information detector 1-45 judges corresponding one of the encoders of the cameras and outputs the transmission request data 1-46′ only to the corresponding encoder.

The information display generator 1-48, on the basis of the contents of the transmission information 1-46, converts the information about the presence or absence of the compressed data on the network 1-25 or about the presence or absence of a unused part in the network transmission capacity to such video data that can be displayed on the monitor 1-31, and outputs the converted data to the video signal integrator 1-29 as the information display video 1-49. How to display the information will be explained later.

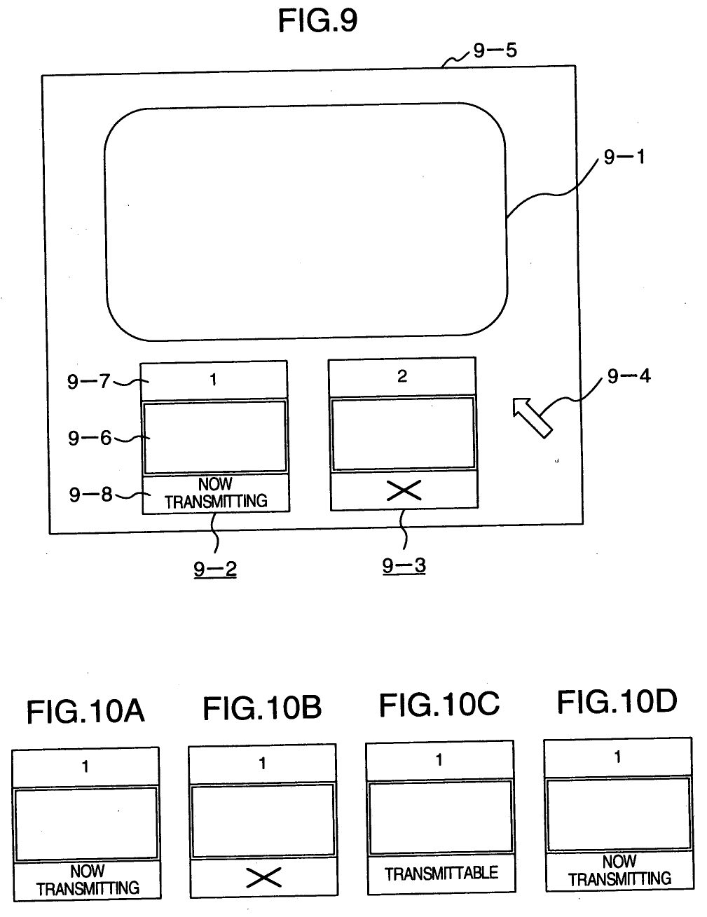

The video signal integrator 1-29 receives four video images of the video signal 1-28, reference video signal 1-39 and 1-42 and information display video 1-49. These video signals are overlapped by the video signal integrator 1-29 so as to be displayed at positions corresponding to the layout of the display screen of the monitor 1-31 and to form such a composite image as shown in FIG. 9. And these video signals are output to the monitor 1-31 as the composite video signal 1-30 corresponding to a single screen of image.

The monitor 1-31 displays the composite video signal 1-30 as the camera video. All the reference images are displayed on the display screen of the monitor 1-31, so that the user can grasp the video images by all the cameras, based on the displayed videos.

The operator console 1-32 is provided in the vicinity of the monitor 1-31, and the user selects one of the camera videos with use of the operator console on the basis of the plurality of reference images displayed on the display screen. Information indicative of the camera video selected by the operator console 1-32 is output to the compressed data selector 1-34 and transmission information detector 1-45 as the camera selection signal 1-33.

The compressed data selector 1-34 selects the compressed data to be expanded on the basis of the information on the received camera selection signal 1-33. In this example, the compressed data corresponding to the camera 1-1 is the compressed data 1-4 and the compressed data corresponding to the camera 1-9 is the compressed data 1-12.

Through the above operations, the user selects one of the compressed data corresponding to desired one of the cameras while viewing the reference images with use of the operator console 1-32, to thereby display the selected camera video on the monitor 1-31.

Explanation will then be made as to how the states of the compressed data on the network 1-25 are displayed on the monitor display screen. An example of displaying the states of the compressed data from the respective cameras is to display the states as combined with the reference images in this case, which is shown in FIG. 9.

FIG. 9 shows an example of a display image 9-5 displayed on the monitor 1-31, which includes a camera video 9-1, a reference screens 9-2 and 9-3, and an instructing pointer 9-4.

The camera video 9-1 is a display of a video image obtained by compressing the camera video in the sender side, transmitting it to the network 1-25, and then expanding it by the decoder 1-27 in the receiver side. In this example, since the two cameras are provided in the sender side, any of the two sorts of camera videos is displayed.

Respective reference images 9-6 obtained by photographing videos by the cameras 1-1 and 1-9 and reducing the video image are displayed on the reference screens 9-2 and 9-3.

Selection of the camera videos is determined by the user who moves the instructing pointer 9-4 (which can be freely moved on the display screen of the monitor) onto desired one of the reference images and issuing an instruction for the camera selection with use of the operator console 1-32. In the case where a mouse is connected to the operator console 1-32 for example, the user moves the instructing pointer 9-4 on the display image 9-5 and stops the pointer on desired one of the reference images by moving the mouse, at which time the video is selected and determined by the user who pushes the button of the mouse.

Through such operations as mentioned above, the user can select one of the connected cameras while viewing the videos currently being taken by the cameras on the basis of the reference images and display the video image of the selected camera on the monitor 1-31 as the camera video 9-1.

In this connection, the display positions and sizes of the camera video 9-1, reference screens 9-2 and 9-3, and instructing pointer 9-4 in the display image 9-5 are not necessarily required to be the same as those in the drawing, and one of various layouts can be considered.

Explanation will now be made more in detail as to the structure of the reference image with use of FIGS. 10A to 10D and the reference screen 9-2. The information display generator 1-48 displays the corresponding camera number 9-7 in a zone of the reference screen 9-2 provided on the upper side of the reference image 9-6, and displays a transmission information representation 9-8 indicative of the condition of the compressed data issued from the camera having the above camera number in a zone of the reference screen 9-2 provided on the lower side of the reference image 9-6. If the desired reference image 9-6 to be selected is selected by the instructing pointer 9-4 under control of the operator console 1-32, then the camera video corresponding to the camera number 9-7 is displayed.

As a result, when the compressed data is present on the network 1-25, the compressed data can be used as video data to be displayed in the receiver terminal.

In this case, as shown in FIG. 10A, a character saying “NOW TRANSMITTING” is displayed in the transmission information representation zone 9-8. The representation is given to all the reference screens 9-2, 9-3, of the compressed data present on the network 1-25.

When no compressed data is present on the network 1-25 and no idle part is present in the network transmission capacity, further, it is impossible to transmit new compressed data to the network 1-25. Thus even when the user selects one of the reference images 9-6 corresponding to the camera number 9-7, the camera video cannot be displayed on the monitor 1-31. In such a case, therefore, “x” is displayed in the transmission information representation zone 9-8 as shown in FIG. 10B so as not to select the reference image 9-6. This representation is given all the reference screens 9-2, 9-3, . . . of the compressed data not present on the network 1-25.

When no compressed data is present on the network 1-25 but there is a idle part left in the network transmission capacity, new compressed data can be transmitted to the network 1-25.

In this case, “TRANSMITTABLE” is given in all the reference images 9-6 of the transmission data not present on the network 1-25 as the transmission information representation zone 9-8, as shown in FIG. 10C.

For example, when the user selects the reference screen 9-2 with use of the operator console 1-32, “NOW TRANSMITTING” is given in the transmission state representation zone 9-8 as shown in FIG. 10D, and the transmission information detector 1-45 outputs the corresponding transmission request data 1-46′ to the encoder connected to the camera having the camera number 9-7. At this time, when a unused or idle part in the network transmission capacity becomes null, that is, the network runs out of its transmission capacity due to the transmission of new compressed data, “x” is given in the transmission information representation zones 9-8 as shown in FIG. 10B for all the reference images 9-6 of the compressed data not present on the network 1-25.

In this way, by combining the reference images 9-6 and transmission information representation zones 9-8, when “NOW TRANSMITTING” or “TRANSMITTABLE” is given in the transmission information representation zone 9-8, the user of the receiver terminal side can select the camera video associated with the camera number 9-7 and, when “x” is given in the transmission information representation zone 9-8, the user can judge that the camera video cannot be selected.

The transmission information representation 9-8 is not always required to be of a character. For example, the information may be represented by differences in color, shape, sound or the like, such as “NOW TRANSMITTING” by blue color and “TRANSMITTABLE” by yellow color, so long as the user in the receiver terminal side can distinguish between the states.

As has been explained in the foregoing, in accordance with the embodiment, there is realized a compressed video image transmission apparatus in which, when the user in the receiver side switchingly changes the camera video while viewing the reference images, the user can judges the transmittable camera video and perform switching operation over the camera videos.

It should be further understood by those skilled in the art that although the foregoing description has been made on embodiments of the invention, the invention is not limited thereto and various changes and modifications may be made without departing from the spirit of the invention and the scope of the appended claims.

1. An image displaying method for use in a video image transmission system for transmitting at least reference video image data from among compressed video image data and reference video image data from a plurality of video image transmission devices via a network, said image displaying method comprising the steps of:
receiving said at least reference video image data from the video image transmission device via the network: and
displaying said at least reference video image data in such a manner in which reference video image data corresponding to receivable compressed video image data and reference video image data corresponding to compressed video image data not receivable are distinguishably displayed.

2. An image transmission method for use in a video image transmission system for transmitting compressed video image data and reference video image data from a plurality of video image transmission devices via a network, said image transmission method comprising the steps of:
allocating a transmission capacity of Q/(N+1) to transmission of each of said compressed video image data, and
allocating a transmission capacity of Q/(N+1) to transmission of N reference video image data,
wherein N of said video image transmission devices are provided and said network has a transmission capacity of Q.

3. An image transmission method for use in a video image transmission system for transmitting at least reference video image data from among compressed video image data and reference video image data from a plurality of video image transmission devices via a network, said image transmission method comprising the steps of:
securing a transmission capacity necessary for transmitting N reference video image data; and
transmitting said N reference video image data using the secured transmission capacity,
wherein N of said video image transmission devices are provided by N.
